(19) United States
(12) Patent Application Publication
(10) Pub. No.: US 2014/0131502 A1
(43) Pub. Date: May 15, 2014

(54) Single Pull Rope Driving Device with a Positioning Effect for a Window Curtain

(71) Applicant: Xiang-Rong Zhu, Macau (MO)

(72) Inventor: Xiang-Rong Zhu, Macau (MO)

(21) Appl. No.: 13/804,042

(22) Filed: Mar. 14, 2013

(30) Foreign Application Priority Data
Nov. 14, 2012 (CN) 201210224253.8

(51) Int. Cl. E06B 9/68

(52) U.S. Cl. CPC E06B 9/68
USPC 242/385.4

(57) ABSTRACT

A single pull rope driving device for a window curtain includes a bracket (1), a reeling drum (2) mounted to the bracket (1), a pull rope (12) for driving the reeling drum (2) to rotate, a gear (7) coupled to the reeling drum (2), a pivotable toothed bar (8) pivotably mounted beside the gear (7), and a spring (11) connected to the pivotable toothed bar (8). The pivotable toothed bar (8) includes a lever (9) with teeth (10). The teeth (10) of the pivotable toothed bar (8) can be engaged with teeth (7a) of the gear (7), preventing rotation of the reeling drum (2). The reeling drum (2) can be driven by moving the pull rope (12) to overcome the spring (11) and to disengage the teeth (10) of the lever (9) from the teeth (7a) of the gear (7).

### BACKGROUND OF THE INVENTION

The present invention relates to a curtain device and, more particularly, to a single pull rope driving device with a positioning effect for a window curtain.

A current technology for releasing/winding a window curtain by pulling a pull rope disclosed in China Patent Publication Nos. CN101634217A; 101263969A; and 101263970A (Application Nos. 200910041288.6; 200810027859.6; and 200810027849.2) includes a single pull rope type rotation driving device, a reeling drum for releasing/winding a curtain cloth or strings connected with a shade, and a positioning device for the curtain cloth or the strings. As shown in FIG. 9, a single pull rope type rotation driving device 3 includes a pull rope rotary disc box 3a fixed to a curtain bracket 1, a pull rope rotary disc 3c rotatably mounted in pull rope rotary disc box 3a and wound with a pull rope 12, and a unidirectional clutch device 6 connected to pull rope rotary disc 3c. A rewinding spring 3e is mounted in pull rope rotary disc 3c. Unidirectional clutch device 6 includes a clutch body 3g integrally formed with pull rope rotary disc box 3a and having an axial hole 3d. A rotary shaft 6a is mounted in axial hole 3d of clutch body 3g for driving a rope reeling device that reels the strings or for driving a reeling drum for reeling the curtain cloth through a transmission shaft 17. A clutch sliding rotary head 6b is located on an end of rotary shaft 6a. Teeth 6c for unidirectional engagement are arranged on two end surfaces respectively of rotary shaft 6a and clutch sliding rotary head 6b. The end surfaces of rotary shaft 6a and clutch sliding rotary head 6b are connected to each other. A jacket 3c1 is formed on a side of pull rope rotary disc 3c. The other end of clutch sliding rotary head 6b is located inside jacket 3c1. An inclined slot 6b1 is formed in an exterior surface of clutch sliding rotary head 6b. Jacket 3c1 includes a slider 3c2 slideably received in inclined slot 6b1. A spring coil 61 is provided between an exterior surface of clutch sliding rotary head 6b and an inner periphery of axial hole 3d of clutch body 3g.

As shown in FIG. 11, unidirectional clutch device 6 may include a chamber 6d defined in pull rope rotary disc box 3a and coaxial to an axis A of pull rope rotary disc box 3a, a driving shaft 6e mounted to pull rope rotary disc 3c and coaxial to axis A, a transmission shaft 6f mounted in chamber 6d, and a driving spring 6g mounted around driving shaft 6e and transmission shaft 6f in chamber 6d and abutting an inner periphery of chamber 6d. Transmission shaft 6f in chamber 6d has an outer diameter not larger than that of driving shaft 6e. Driving spring 6g is in tight contact with driving shaft 6e and the inner periphery of chamber 6d. Transmission shaft 6f is extended out of chamber 6d and connected to a reeling drum 2.

As shown in FIGS. 9 and 10, a positioning device 5 includes a sleeve 5a integrally formed with pull rope rotary disc box 3a and a sleeve shaft 5b mounted in sleeve 5a and connected to rotary shaft 6a through transmission shaft 17. Transmission shaft 17 extends into and is connected to sleeve shaft 5b. An interior side wall of sleeve 5a is provided with a guide groove 5c. A continuous sliding path 5e is formed along a surface 5d of sleeve shaft 5b. A ball 5f is mounted between guide groove 5c and sliding path 5e. As shown in FIG. 10, sliding path 5e is comprised of one or more groups of left and right sliding paths 5e1, 5e2 and an intermediate V-shaped sliding path 5e3. In a direction of left sliding path 5e1 and intermediate sliding path 5e3 there are guiding mouths 5e4, 5e5 for respective directions to right sliding path 5e2 and left sliding path 5e1. In another direction of right sliding path 5e2 there is a guide mouth 5e6 for direction to intermediate V-shaped sliding path 5e3. In operation, sleeve shaft 5b is rotated together with transmission shaft 17 such that ball 5f displaces axially along guide groove 5c and moves along sliding path 5e. When sleeve shaft 5b is rotated in a direction allowing ball 5f to enter right sliding path 5e2, sleeve shaft 5b is smoothly rotated to actuate transmission shaft 17 to rotate. When sleeve shaft 5b stops rotating, transmission shaft 17 is driven as a result of the gravity acting on the curtain cloth or the shade. Accordingly, sleeve shaft 5b is slightly rotated in a reverse direction to thereby allow ball 5f to pass through guide mouth 5e6 to enter intermediate V-shaped sliding path 5e3 and to be trapped therein, whereby sleeve shaft 5b is unable to be rotated reversely, until sleeve shaft 5b is rotated by rotation driving device 3 through a small angle in the direction of retracting the curtain cloth or the shade, such that ball 5f is allowed to pass through guiding mouth 5e5 from intermediate V-shaped sliding path 5e3 and into left sliding path 5e1 and is, thus, no longer trapped in intermediate V-shaped sliding path 5e3.

In this way, reeling drum 2 is driven by rotation driving device 3 to rotate in a direction. If drawing of pull rope 12 is stopped after the released curtain cloth or the strings reaches a predetermined length, reeling drum 2 will be stopped from rotation under the positioning action of positioning device 5. However, as limited by the structure of positioning device 5, reeling drum 2 normally rewinds about half a circle before it is completely positioned. Thus, if the user requires precise control of the released length of the curtain cloth or the strings, the user must know the rewound length of reeling drum 2 and pull out the curtain cloth or the strings by an additional travel according to the rewound length of reeling drum 2. However, most users do not know the exact additional travel of pull rope 12 for compensating the rewound length, causing inconvenience to the users.

### BRIEF SUMMARY OF THE INVENTION

It is an objective of the present invention to provide a single pull rope driving device with a positioning effect for a window curtain. The single pull rope driving device can precisely position the window curtain, allows convenient use, and has a simple structure.

The present invention fulfills the above objective by providing a single pull rope driving device including a bracket. A reeling drum is mounted to the bracket for releasing/winding a curtain cloth or cords for connected with shutters of a shade. The single pull rope driving device further includes a pull rope for driving the reeling drum to rotate in a releasing or winding direction. A gear is coupled to the reeling drum and includes a plurality of teeth. A pivotable toothed bar is pivotably supported beside the gear and includes a lever having at least one tooth releasably engaged with the teeth of the gear. The lever includes a lower end located below the gear in a vertical direction and actuatable by the pull rope. The single pull rope driving device further includes a spring coupled to the pivotable toothed bar. When the at least one tooth on the lever engaged with the teeth of the gear, the gear and the reeling drum are prevented from rotation. When the pull rope is moved to actuate the lever, the lever is pivoted to disengage the at least one tooth on the lever from the gear, allowing the reeling drum to be driven by downwardly pulling the pull rope.

In order to ensure the pull rope always abuts the lever of the pivotable toothed bar, the lever further includes an extension transversely extending from the lower end of the lever. A through-hole is formed in the extension of the lever, and the pull rope extends through the through-hole.

In an embodiment, the lever includes an upper end pivotably coupled to a pin adapted to be mounted to a pull rope rotary disc box fixed to the bracket. The lower end of the lever is spaced from the pin in a horizontal direction perpendicular to the vertical direction. The spring is a torsion spring and biases the lever to engage the at least one tooth on the lever with the teeth of the gear. The spring includes a first tang adapted to be attached to the pull rope rotary disc box. The spring further includes a second tang connected to the upper end of the lever. In another embodiment, the spring is a V-shaped spring including a first tang and a second tang. The first tang is adapted to be pivotably connected to the pull rope rotary disc box, and the second tang is pivotally connected to the upper end of the lever.

Preferably, each of the teeth of the gear is a ratchet tooth having an upright edge and an inclined edge located behind the upright edge in the winding direction of reeling drum. The at least one tooth of the pivotable toothed bar is a ratchet tooth and includes an upright edge facing the upright edge of one of the teeth of the gear. The upper end of the lever has a shape allowing the at least one tooth on the lever to engage with the teeth of the gear.

In comparison with the prior art, the single pull rope driving device of the present invention has advantages of precise positioning, convenient use, and simple structure.

The present invention will become clearer in light of the following detailed description of illustrative embodiments of this invention described in connection with the drawings.

### DESCRIPTION OF THE DRAWINGS

FIG. 1 shows a schematic side view of a single pull rope driving device of a first embodiment of the present invention.

FIG. 2 is a schematic elevational view of the single pull rope driving device of FIG. 1.

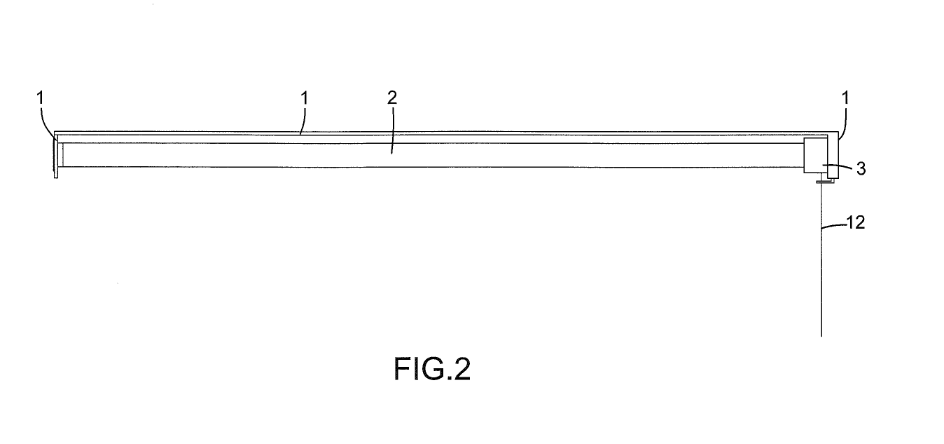

FIG. 3a shows a view similar to FIG. 1, illustrating a second embodiment of the single pull rope driving device, with a torsion spring in FIG. 1 replaced by a V-shaped spring.

FIG. 3b shows a view similar to FIG. 3a, with a pivotable toothed bar engaged with a gear.

FIG. 4a is a partial, cross-sectional view of the single pull rope driving device of FIG. 1.

FIG. 4b is a partial, cross-sectional view of the single pull rope driving device of FIG. 3a.

FIG. 5 is a view similar to FIG. 4b, illustrating another embodiment of the single pull rope driving device including a positioning device.

FIG. 6 shows a view similar to FIG. 1, with the pivotable toothed bar disengaged from the gear.

FIG. 7 is a perspective view of the pivotable toothed bar.

FIG. 8 is a perspective view illustrating use of the single pull rope driving device of the present invention on a window curtain.

FIG. 9 is a partial, cross-sectional view showing structure of a conventional single pull rope driving device.

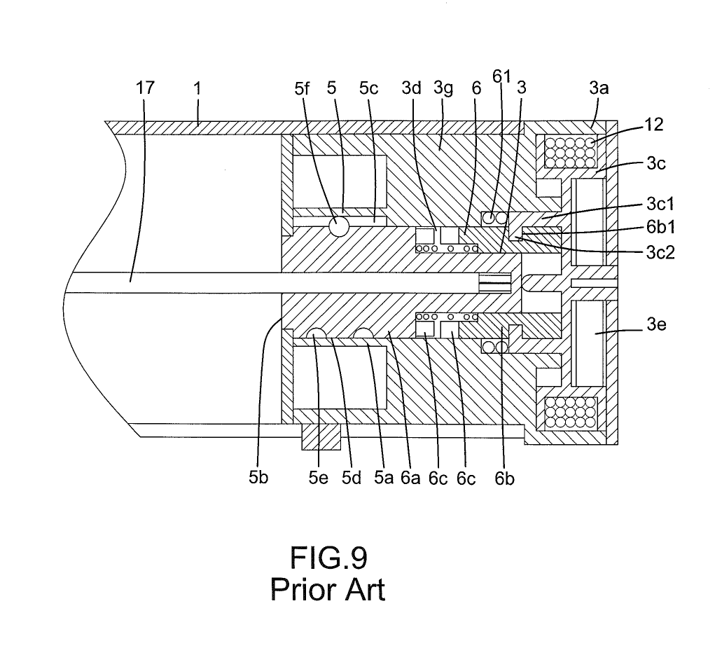

FIG. 10 shows a flattened view of a surface of a sleeve of a reverse rotation releasing device of FIG. 9.

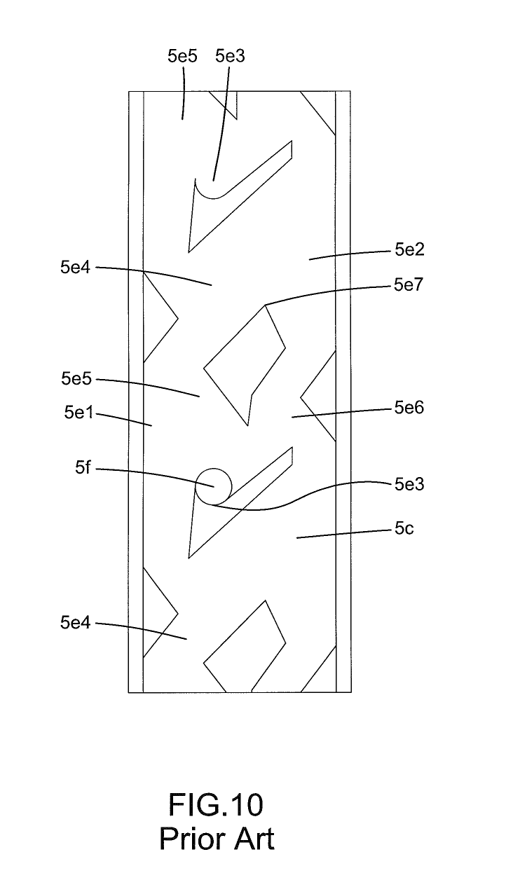

FIG. 11 is a partial, cross-sectional view showing structure of another conventional single pull rope driving device.

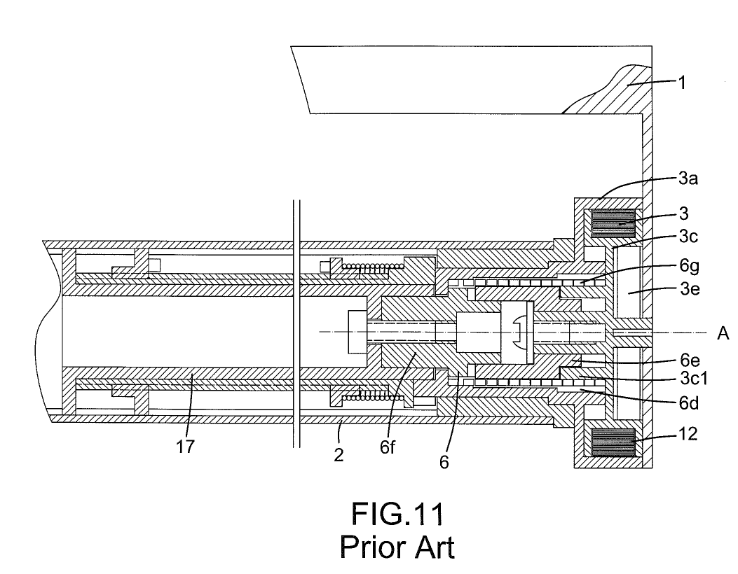

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “lower”, “upper”, “left”, “right”, “inner”, “outer”, “end”, “horizontal”, “vertical”, “downward”, “outward”, “inward”, “clockwise”, “counterclockwise”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

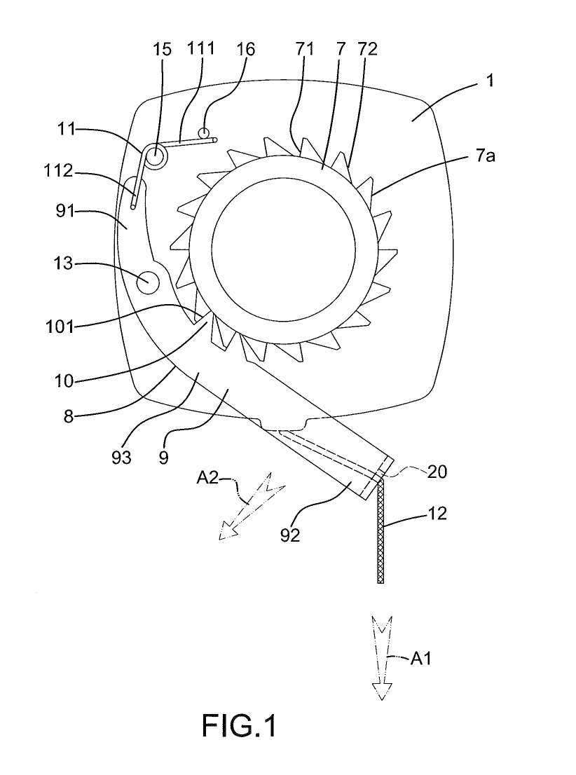

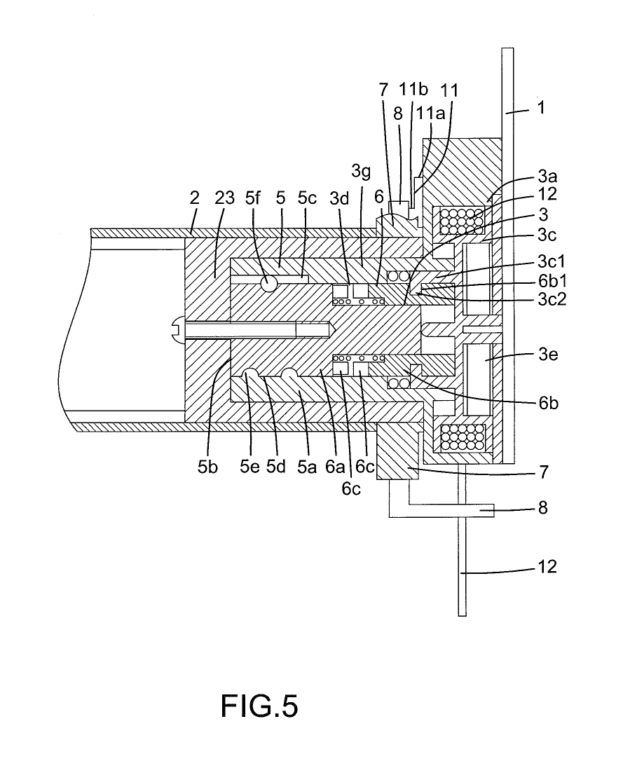

With reference to FIGS. 1 2, and 4a, a single pull rope driving device for a window curtain according to the present invention generally includes a bracket 1. A reeling drum 2 is mounted to bracket 1 for releasing/winding a curtain cloth. A rotation driving device 3 of single pull rope type is mounted to bracket 1 for driving reeling drum 2 to rotate. A gear 7 is coupled to reeling drum 2 and located outside of bracket 1. A pivotable toothed bar 8 is pivotably supported beside gear 7. In this embodiment, rotation driving device 3 includes a pull rope rotary disc box 3a fixed to bracket 1. A pull rope rotary disc 3c is rotatably mounted in pull rope rotary disc box 3a and wound with a pull rope 12. Gear 7 is located outside of pull rope rotary disc box 3a and coupled to reeling drum 2 by a connecting sleeve 23. Connecting sleeve 23 can be fixed to a sleeve shaft 5b of a positioning device 5, as shown in FIG. 5. Gear 7 includes a plurality of teeth 7a on an outer periphery thereof. Each tooth 7a of gear 7 is a ratchet tooth and includes an upright edge 71 and an inclined edge 72 located behind the upright edge 71 in the winding direction of reeling drum 2 (the counterclockwise direction as viewed from FIG. 1). A protective housing 18 is mounted around gear 7 to protect gear 7 and associated members.

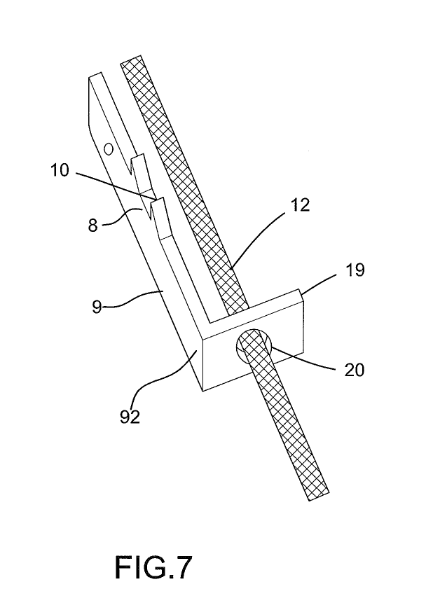

Pivotable toothed bar 8 is pivotably mounted on pull rope rotary disc box 3a and has a lever 9. Lever 9 includes an upper end 91 pivotably coupled to a pin 13 mounted to pull rope rotary disc box 3a or bracket 1. Lever 9 further includes a lower end 92 located below gear 7 in a vertical direction and spaced from pin 13 in a horizontal direction perpendicular to the vertical direction. A plurality of teeth 10 is formed on an intermediate portion 93 between upper and lower ends 91 and 92 of lever 9 and corresponds to some of teeth 7a of gear 7. In this embodiment, each tooth 10 of lever 9 is a ratchet tooth and includes an upright edge 101 facing upright edge 71 of an associated tooth 7a of gear 7. Further, upper end 91 of lever 9 has a shape allowing all teeth 10 on lever 9 to simultaneously engage with teeth 7a of gear 7. An extension 19 extends transversely from an inner side of lower end 92 of lever 9, as shown in FIG. 7. A through-hole 20 is formed in extension 19, and pull rope 12 extends through through-hole 20, allowing smooth pulling of pull rope 12.

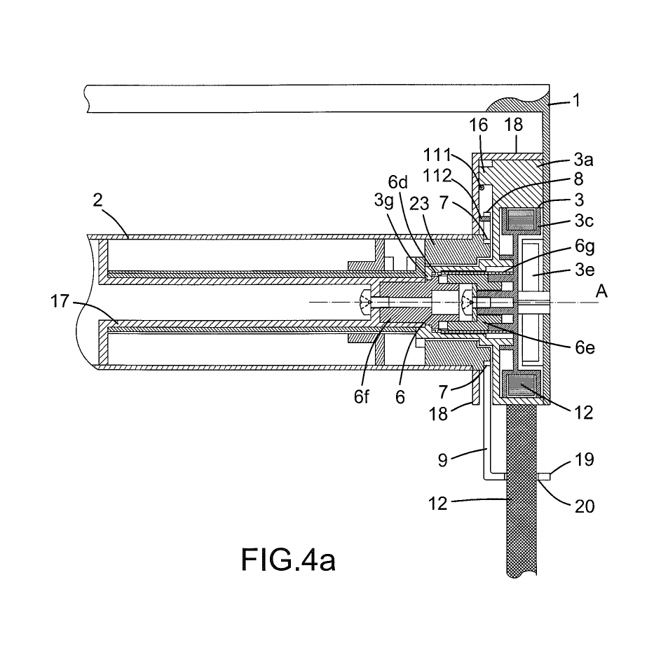

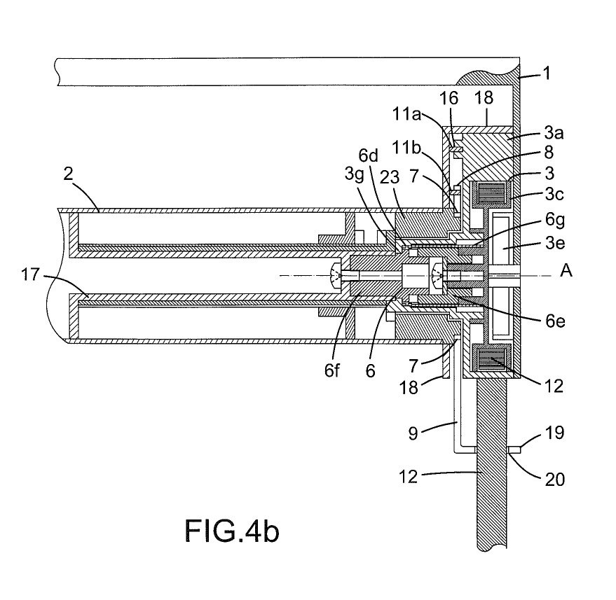

Single pull rope driving device according to the present invention further includes a spring 11 mounted between pivotable toothed bar 8 and pull rope rotary disc box 3a or bracket 1. According to the embodiment shown in FIGS. 1 and 4a, spring 11 is a torsion spring and mounted around a peg 15. A first tang 111 of torsion spring 11 abuts against a positioning post 16 provided on pull rope rotary disc box 3a, and a second tang 112 of torsion spring 11 is connected to upper end 91 of lever 9.

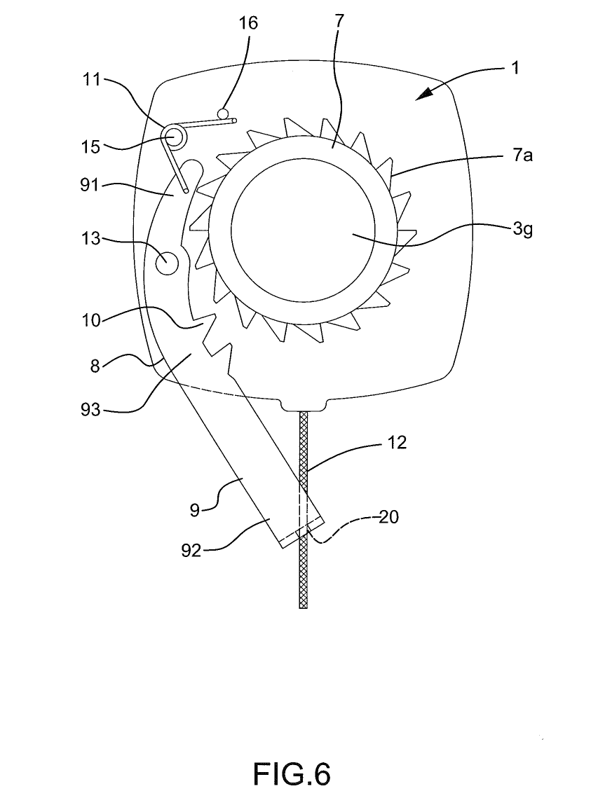

In operation, when pull rope 12 is in a free state, torsion spring 11 biases upper end 91 of lever 9 away from gear 7 (see FIG. 1), causing teeth 10 on lever 9 to engage with teeth 7a of gear 7. When pull rope 12 is moved downward (see arrow A1 in FIG. 1), pull rope 12 will press against an inner periphery of through-hole 20, so that lever 9 is clockwise pivoted about pin 13 (see arrow A2 in FIG. 1) to produce a pivotal force to overcome spring 11, causing teeth 10 on lever 9 to disengage from teeth 7a of gear 7, as shown in FIG. 6. Thus, reeling drum 2 can freely rotate in the releasing or winding direction by pulling pull rope 12. After the curtain cloth is unreeled or reeled to a desired length, if pull rope 12 in FIG. 6 is released, lever 9 will be counterclockwise pivoted about pin 13 under the action of spring 11 so that teeth 10 on lever 9 are engaged with teeth 7a of gear 7 to stop gear 7 from rotation (see FIG. 1). At the same time, reeling drum 2 cannot be rotated either, achieving the positioning purposes. By providing gear 7 with a number of teeth 7a and by utilizing teeth 10 on lever 9 engaged with teeth 7a of gear 7, reeling drum 2 only rotates through a small angle in the rewinding rotation before it is completely positioned. Thus, a user can easily carry out precise positioning. Further, with the ratchet teeth 7a and 10, the precise positioning for reeling drum 2 can be more effectively achieved. However, lever 9 can include only one tooth 10 if desired.

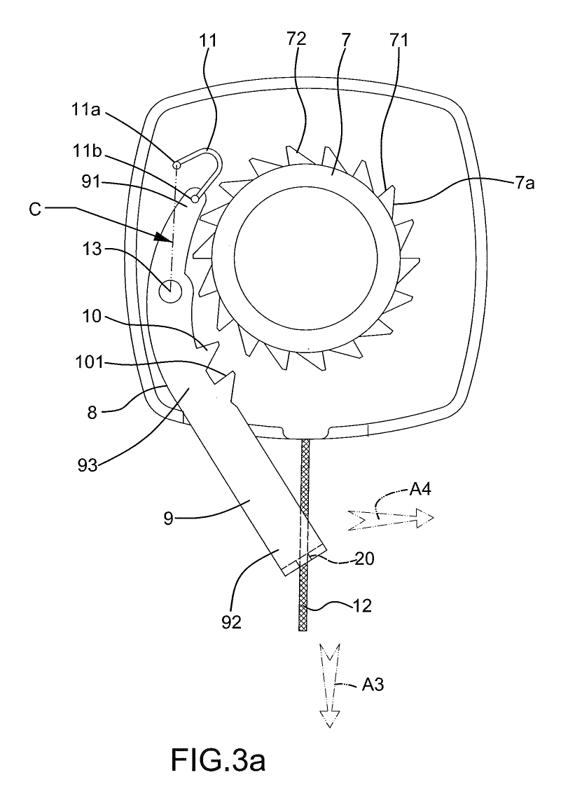

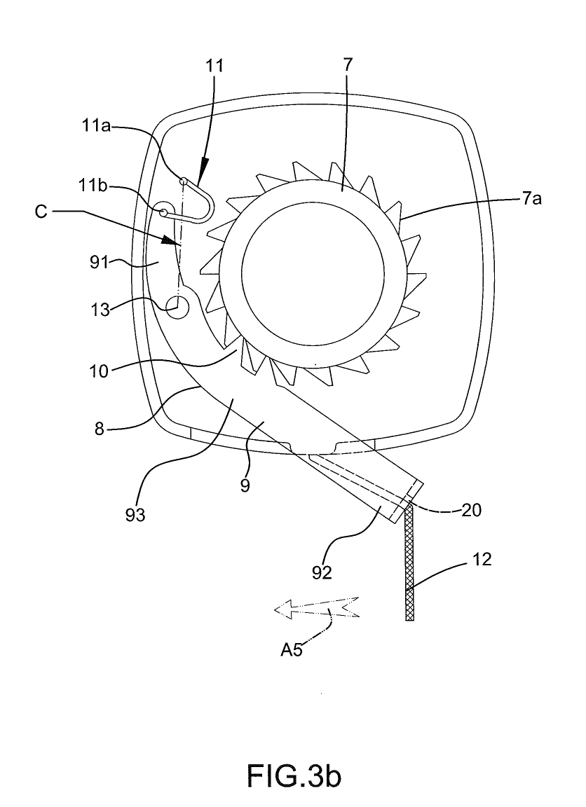

FIGS. 3a, 3b, and 4b, show another embodiment of spring 11 according to the present invention. In this embodiment, spring 11 is a V-shaped spring including a first tang 11a pivotably received in pull rope rotary disc box 3a and a second tang 11b pivotably received in upper end 91 of lever 9. In operation, as shown in FIG. 3a, in a case that second tang 11b of spring 11 is located between gear 7 and first tang 11a (second tang 11b of spring 11 is between gear 7 and a line C passing through first tang 11a of spring 11 and pin 13), teeth 10 on lever 9 are disengaged from teeth 7a of gear 7, so that reeling drum 2 can freely rotate in the releasing or winding direction by pulling pull rope 12 downward (see arrow A3 in FIG. 3a). When the curtain cloth is reeled or unreeled to a desired location, if pull rope 12 is moved inward in the horizontal direction (see arrow A4 in FIG. 3a), pull rope 12 will press against the inner periphery of through-hole 20, so that lever 9 is counterclockwise pivoted about pin 13 to produce a pivotal force to press second tang 11b of spring 11 toward first tang 11a. Thus, spring 11 can be clockwise pivoted about first tang 11a, and lower end 92 of lever 9 will be pivoted toward gear 7, causing teeth 10 on lever 9 to engage with teeth 7a of gear 7 to stop gear 7 from rotation for positioning purposes, as shown in FIG. 3b (line C is between gear 7 and second tang 11b of spring 11). On the other hand, when pull rope 12 in FIG. 3b is moved outward in the horizontal direction (see arrow A5 in FIG. 3b), pull rope 12 will press against the inner periphery of through-hole 20, so that lever 9 is clockwise pivoted about pin 13 to produce a pivotal force to press second tang 11b of spring 11 toward first tang 11a, such that spring 11 can be counterclockwise pivoted about first tang 11a, and upper end 91 of lever 9 is pivoted toward gear 7, causing teeth 10 on lever 9 to disengage from teeth 7a of gear 7, as shown in FIG. 3a. Thus, reeling drum 2 can freely rotate in the releasing or winding direction again by pulling pull rope 12.

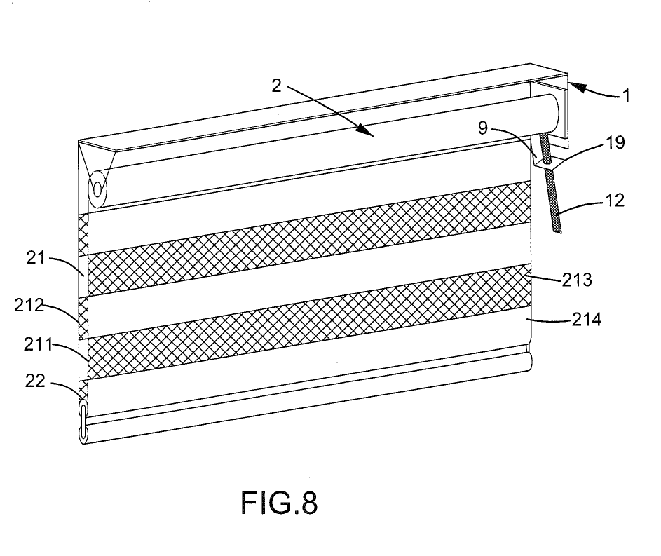

As shown in FIG. 8, the single pull rope driving device of the present invention can be applied to a window curtain of a type having a curtain cloth 21 with front and rear portions 211 and 212. An end of curtain cloth 21 is fixed to bracket 1, and the other end of curtain cloth 21 is wound around reeling drum 2. A weight 22 in the form of a tube is provided on a lower end of curtain cloth 21. Each of front and rear portions 211 and 212 includes alternately disposed light-transmittable sections 213 and opaque sections 214. Since the single pull rope driving device of the present invention is capable of precisely positioning curtain cloth 21, light-transmittable sections 213 of front and rear portions 211 and 212 can be easily adjusted to be aligned or not aligned with each other according to need, allowing curtain cloth 21 to be opened or closed.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A single pull rope driving device for a window curtain comprising:
a bracket (1);
a reeling drum (2) mounted to the bracket (1) and adapted to release/wind a curtain cloth;
a pull rope (12) for driving the reeling drum (2) to rotate in a releasing or winding direction;
a gear (7) coupled to the reeling drum (2), with the gear (7) including a plurality of teeth (7a);
a pivotable toothed bar (8) pivotably supported beside the gear (7), with the pivotable toothed bar (8) including a lever (9) having at least one tooth (10) releasably engaged with the plurality of teeth (7a) of the gear (7), with the lever (9) including a lower end (92) located below the gear (7) in a vertical direction and actuatable by the pull rope (12); and
a spring (11) coupled to the pivotable toothed bar (8),
with the at least one tooth (10) on the lever (9) engaged with the plurality of teeth (7a) of the gear (7), the gear (7) and the reeling drum (2) are prevented from rotation,
wherein when the pull rope (12) is moved to actuate the lever (9), the lever (9) is pivoted to disengage the at least one tooth (10) on the lever (9) from the gear (7), allowing the reeling drum (2) to be driven by downwardly pulling the pull rope (12).

2. The single pull rope driving device according to claim 1, with the lever (9) further including an extension (19) extending transversely from the lower end (92) of the lever (9), with a through-hole (20) formed in the extension (19) of the lever (9), with the pull rope (12) extending through the through-hole (20).

3. The single pull rope driving device according to claim 1, with the lever (9) including an upper end (91) pivotably coupled to a pin (13), with the pin (13) adapted to be mounted to a pull rope rotary disc box (3a) fixed to the bracket (1), with the lower end (92) of the lever (9) spaced from the pin (13) in a horizontal direction perpendicular to the vertical direction, with the spring (11) being a torsion spring and biasing the lever (9) to engage the at least one tooth (10) on the lever (9) with the plurality of teeth (7a) of the gear (7), with the spring (11) including a first tang (111) and a second tang (112), with the first tang (111) of the spring (11) adapted to be attached to the pull rope rotary disc box (3a), with the second tang (112) of the spring (11) connected to the upper end (91) of the lever (9).

4. The single pull rope driving device according to claim 1, with the lever (9) including an upper end (91) pivotably coupled to a pin (13), with the pin (13) adapted to be mounted to a pull rope rotary disc box (3a) fixed to the bracket (1), with the lower end (92) of the lever (9) spaced from the pin (13) in a horizontal direction perpendicular to the vertical direction, with the spring (11) being a V-shaped spring including a first tang (11a) and a second tang (11b), with the first tang (11a) adapted to be pivotably connected to the pull rope rotary disc box (3a), with the second tang (11b) pivotally connected to the upper end (91) of the lever (9).

5. The single pull rope driving device according to claim 1, with each of the plurality of teeth (7a) of the gear (7) being a ratchet tooth having an upright edge (71) and an inclined edge (72) located behind the upright edge (71) in the winding direction of reeling drum (2), with the at least one tooth (10) of the pivotable toothed bar (8) being a ratchet tooth and including an upright edge (101) facing the upright edge (71) of one of the plurality of teeth (7a) of the gear (7).

6. The single pull rope driving device according to claim 5, with the upper end (91) of the lever (9) having a shape allowing the at least one tooth (10) on the lever (9) to engage with the plurality of teeth (7a) of the gear (7).
